(19) United States
(12) Patent Application Publication
(10) Pub. No.: US 2026/0102299 A1
(43) Pub. Date: Apr. 16, 2026

(54) BED RAIL PADDING DEVICE

(71) Applicant: Marie Flarissaint, Middleburg, FL (US)

(72) Inventor: Marie Flarissaint, Middleburg, FL (US)

(21) Appl. No.: 18/916,097

(22) Filed: Oct. 15, 2024

(51) Int. Cl. A61G 7/05

(52) U.S. Cl. CPC A61G 7/0507; A61G 2203/70

(57) ABSTRACT

A bed rail padding device includes a hospital bed which has a plurality of side rails to inhibit the patient from falling off of the hospital bed. A plurality of side rail covers is each positionable over a respective one of the plurality of side rails of the hospital bed to inhibit the patient from being injured in the event that the patient experiences the seizure which results in the patient striking laterally against the side rails of the hospital bed. A plurality of cushions is strategically positioned on a respective one of the plurality of side rail covers to inhibit the patient from being injured when the patient strikes downwardly on the respective side rail of the hospital bed in the event that the patient is experiencing the seizure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bed rail devices and more particularly pertains to a new bed rail device for inhibiting a patient from being injured as a result of striking against side rails of a bed when the patient is experiencing a seizure. The device includes a hospital bed that has a plurality of side rails and a plurality of side rail covers which are each positionable over a respective side rail of the hospital bed to protect a patient from being injured when the patient strikes laterally against a side rail of the bed as the result of a seizure. The device includes a plurality of cushions which are each attached to a respective side rail cover to protect the patient from being injured when the patient strikes downwardly on a side rail of the bed as a result of a seizure.

### (2) Description of Related Art Including Information Disclosed Under 37 CFR 1.97 and 1.98

The prior art relates to bed rail devices including: a padded cover device that includes a pair of padded panels that are hinged together to enclose a side rail of a hospital bed; a protective covering device that includes tubular cushions that are positionable around member of side rails of a bed and slip covers that are positionable over the tubular cushions; a slip cover device that includes a slip cover that can be positioned over a side rail of a bed and a bolster attached to the slip cover to inhibit a person's limbs from falling between the side rail and a mattress of the bed; a pad device that includes a foam pad that is strategically structured to be positioned over a rail of a bed to cushion the rail. In no instance does the prior art disclose a bed rail padding device that includes a plurality of side rail covers that are each positionable over a respective side rail of a bed which are each comprised of a resiliently compressible material to protect a patient from being injured when the patient laterally strikes against the side rail and a plurality of cushions that are each positioned on top of a respective side rail cover to protect the patient from being injured when the patient strikes downwardly on the side rail.

### BRIEF SUMMARY OF THE INVENTION

An embodiment of the disclosure meets the needs presented above by generally comprising a hospital bed which has a plurality of side rails to inhibit the patient from falling off of the hospital bed. A plurality of side rail covers is each positionable over a respective one of the plurality of side rails of the hospital bed to inhibit the patient from being injured in the event that the patient experiences the seizure which results in the patient striking laterally against the side rails of the hospital bed. A plurality of cushions is strategically positioned on a respective one of the plurality of side rail covers to inhibit the patient from being injured when the patient strikes downwardly on the respective side rail of the hospital bed in the event that the patient is experiencing the seizure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a bed rail padding device according to an embodiment of the disclosure.

FIG. 2 is a front view of a side rail cover of an embodiment of the disclosure.

FIG. 3 is a top view of a lateral side rail cover an embodiment of the disclosure.

FIG. 4 is a back view of a lateral side rail cover of an embodiment of the disclosure.

FIG. 5 is a front phantom view of a lateral side rail cover of an embodiment of the disclosure.

FIG. 6 is a bottom view of a lateral side rail cover of an embodiment of the disclosure.

FIG. 7 is a perspective in-use view of an embodiment of the disclosure.

### DETAILED DESCRIPTION OF THE INVENTION

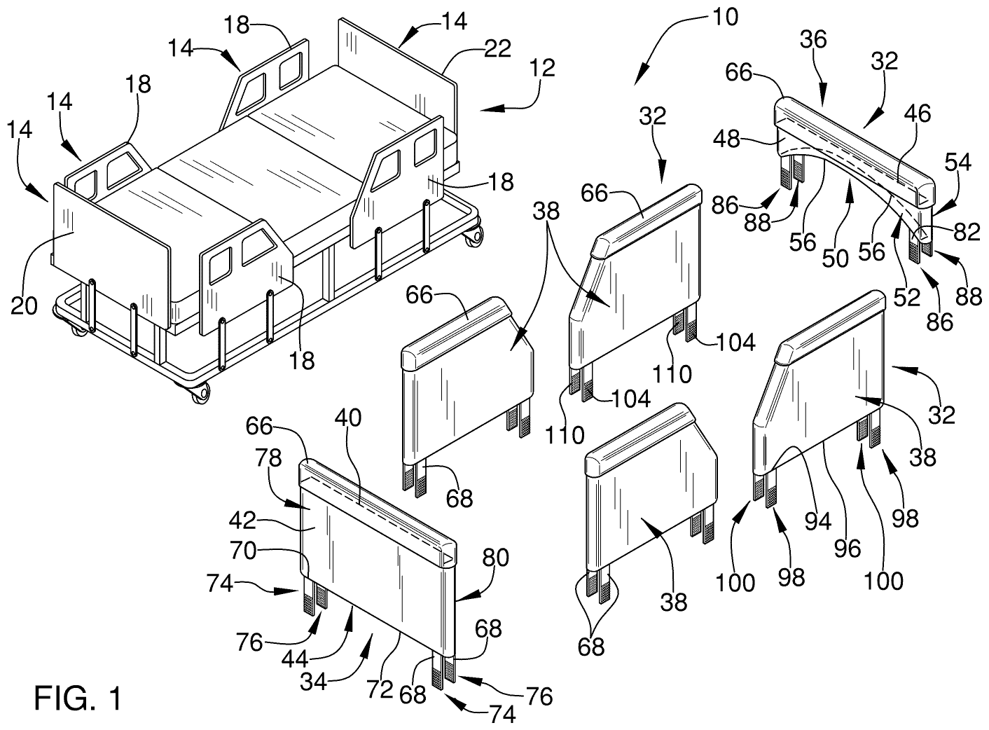

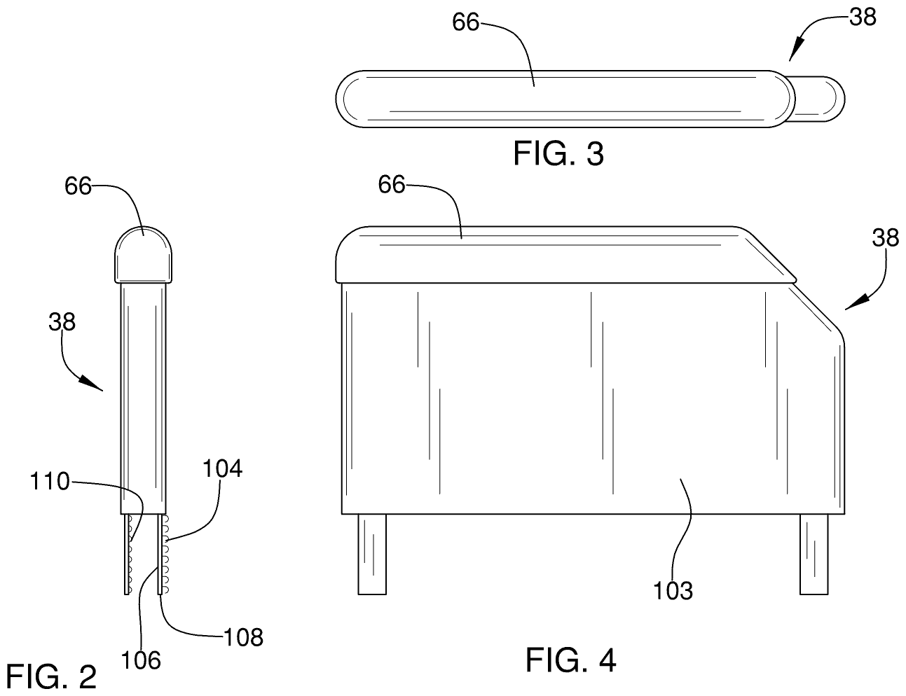

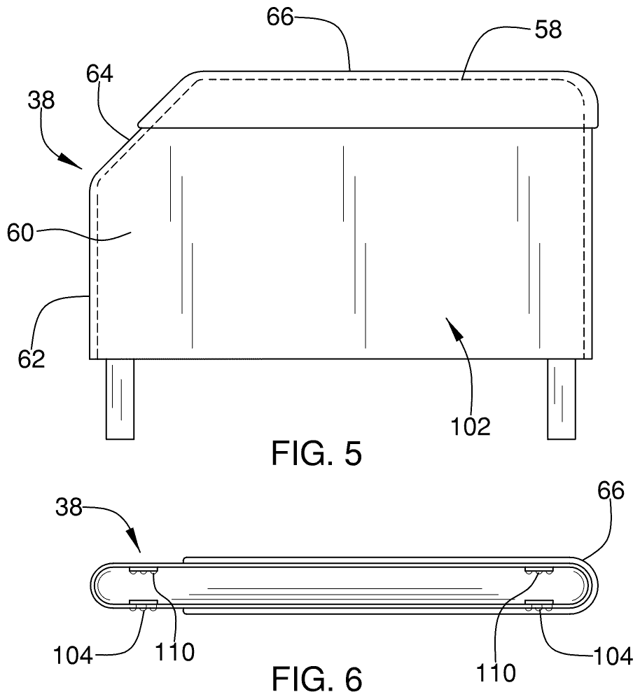

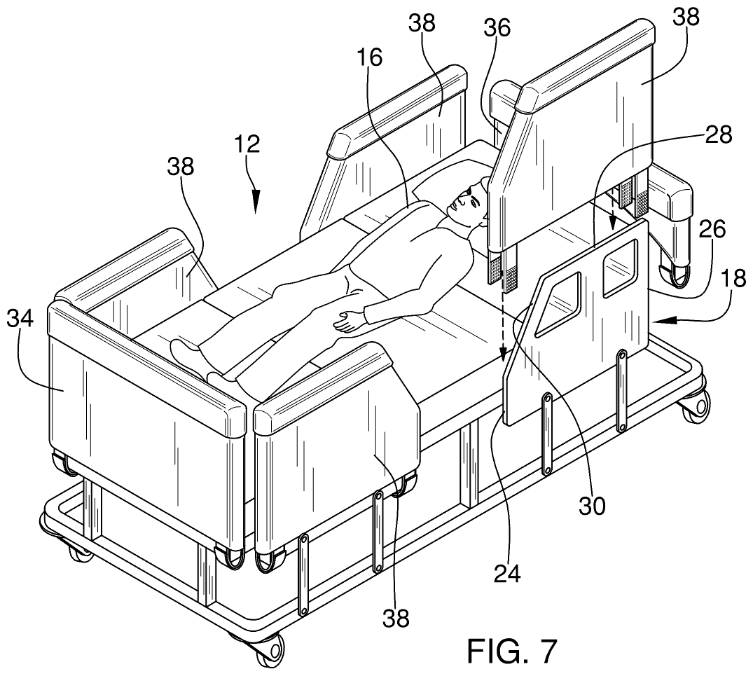

With reference now to the drawings, and in particular to FIGS. 1 through 7 thereof, a new bed rail device embodying the principles and concepts of an embodiment of the disclosure and generally designated by the reference numeral 10 will be described.

As best illustrated in FIGS. 1 through 7, the bed rail padding device 10 generally comprises a hospital bed 12 which has a plurality of side rails 14 that is distributed around a perimeter of the hospital bed 12 to inhibit a patient 16 from falling off of the hospital bed 12. The plurality of side rails 14 includes a set of lateral side rails 18, a front side rail 20 and a back side rail 22. Each of the set of lateral side rails 18 has a front edge 24, a back edge 26, a top edge 28 and a sloped edge 30 which slopes upwardly between the front edge 24 and the top edge 28. Furthermore, the hospital bed 12 may comprise a hospital bed of any conventional design that might commonly be found in a hospital, a nursing home or any other facility that involves the care of patients 16 that might suffer from a seizure or other type of neurological disorder that involves involuntary movement of the patient's 16 limbs or body.

A plurality of side rail covers 32 is provided and each of the plurality of side rail covers 32 is positionable over a respective one of the plurality of side rails 14 of the hospital bed 12 such that each of the plurality of side rail covers 32 substantially encloses the respective side rail 14 of the hospital bed 12. Each of the plurality of side rail covers 32 is comprised of a resiliently compressible material, including but not being limited to silicone or rubber, to inhibit the patient 16 from being injured in the event that the patient 16 experiences the seizure which results in the patient 16 striking laterally against the side rails 14 of the hospital bed 12. Furthermore, the resiliently compressible material comprises a material that is pliable yet firm enough to enable the plurality of side rail covers 32 to maintain their shape.

The plurality of side rail covers 32 includes a front side rail cover 34 and a back side rail cover 36 and a set of lateral side rail covers 38. The front side rail cover 34 has a top wall 40 and a perimeter wall 42 extending downwardly from the top wall 40 such that the perimeter wall 42 of the front side rail cover 34 defines an interior space 44 of the front side rail cover 34. Furthermore, the interior space 44 of the front side rail cover 34 insertably receives the front side rail 20 of the hospital bed 12. The back side rail cover 36 has a top wall 46 and a perimeter wall 48 extending downwardly from the top wall 46 of the back side rail cover 36 such that the perimeter wall 48 of the back side rail cover 36 defines an interior space 50 of the back side rail cover 36. Furthermore, the interior space 50 of the back side rail cover 36 insertably receives the back side rail 22 of the hospital bed 12. The perimeter wall 48 of the back side rail cover 36 has a front side 52 and a back side 54 and a bottom edge 56. The bottom edge 56 of the front side 52 curves upwardly toward the top wall 46 of the back side rail cover 36 to accommodate a pillow on the hospital bed 12. Additionally, the bottom edge 56 of the back side 54 curves upwardly toward the top wall 46 of the back side rail cover 36 to accommodate the pillow on the hospital bed 12.

Each of the set of lateral side rail covers 38 has a top wall 58 and a perimeter wall 60 extending downwardly from the top wall 58 of a respective lateral side rail cover 38. The perimeter wall 60 of each of the set of lateral side rail covers 38 has a forward side 62 and a sloped side 64 which slopes upwardly between the forward side 62 and the top wall 58 of a respective lateral side rail cover 38. In this way the forward side 62 and the sloped side 64 of the perimeter wall 60 of each of the set of lateral side rail covers 38 can conform to the front edge 24 and the sloped edge 30 of a respective lateral side rail 18 of the hospital bed 12.

A plurality of cushions 66 is provided and each of the plurality cushions 66 is strategically positioned on a respective one of the plurality of side rail covers 32. Each of the plurality of cushions 66 extends over the respective side rail 14 of the hospital bed 12 on which the respective side rail cover 32 is positioned. Each of the plurality of cushions 66 is comprised of a resiliently compressible material, including but not being limited to rubber or silicone, to inhibit the patient 16 from being injured when the patient 16 strikes downwardly on the respective side rail 14 of the hospital bed 12 in the event that the patient 16 is experiencing the seizure. Additionally, each of the plurality of cushions 66 has a thickness that is greater than a thickness of the respective side rail cover 32 on which each of the plurality of cushions 66 is positioned. In this way each of the plurality of cushions 66 enhances protection for the patient 16 when the patient 16 strikes downwardly on the respective side rail 14 of the hospital bed 12 when the patient 16 is experiencing the seizure.

The cushion 66 on the front side rail cover 34 extends along a full length of the top wall 40 of the front side rail cover 34. The cushion 66 on the back side rail cover 36 extends along a full length of the top wall 46 of the back side rail cover 36. The cushion 66 on a respective lateral side rail cover 38 extends along a full length of the top wall 58 of the respective lateral side rail cover 38. Furthermore, the cushion 66 on the respective lateral side rail cover 38 terminates at the sloped side 64 of the perimeter wall 60 of the respective lateral side rail cover 38.

A plurality of straps 68 is provided and each of the plurality of straps 68 is coupled to and extends downwardly from a respective one of the plurality of the side rail covers 32. Each of the plurality of straps 68 on a respective one of the plurality of side rail covers 32 is extendable beneath the respective side rail of the hospital bed 12 on which the respective side rail cover 32 is positioned. In this way the respective side rail cover 32 can be secured on the respective side rail 14 of the hospital bed 12. Additionally, a respective pair of the plurality of straps 68 on a respective one of the plurality of side rail covers 32 is releasably matable to each other to inhibit the respective side rail cover 32 from being removed from the respective side rail 14 of the hospital bed 12.

Each of the plurality of straps 68 associated with the front side rail cover 34 has an upper end 70 which is attached to a bottom edge 72 of the perimeter wall 42 of the front side rail cover 34. The plurality of straps 68 associated with the front side rail cover 34 includes a set of front straps 74 and a set of back straps 76. Each of the set of front straps 74 is positioned on a front side 78 of the perimeter wall 42 of the front side rail cover 34 and each of the set of back straps 68 is positioned on a back side 80 of the perimeter wall 42 of the front side rail cover 34. Furthermore, a respective one of the set of front straps 68 is releasably matable to a respective one of the set of back straps 68.

Each of the plurality of straps 68 associated with the back side rail cover 36 has an upper end 82 which is attached to the bottom edge 56 of the perimeter wall 48 of the back side rail cover 36. The plurality of straps 68 associated with the back side rail cover 36 includes a set of front straps 86 and a set of back straps 88. Each of the set of front straps 86 associated with the back side rail cover 36 is positioned on the front side 52 of the perimeter wall 48 of the back side rail cover 36. Each of the set of back straps 88 associated with the back side rail cover 36 is positioned on the back side 54 of the perimeter wall 48 of the back side rail cover 36. Furthermore, a respective one of the set of front straps 86 associated with the back side rail cover 36 is releasably matable to a respective one of the set of back straps 88 associated with the back side rail cover 36.

Each of the plurality of straps 68 associated with a respective one of the pair of lateral side rail covers 38 has an upper end 94 which is attached to a bottom edge 96 of the perimeter wall 60 of the respective lateral side rail cover 38. The plurality of straps 68 associated with each of the pair of lateral side rail covers 38 includes a set of front straps 98 and a set of back straps 100. Each of the set of front straps 98 associated with a respective lateral side rail cover 38 is positioned on a front side 102 of the perimeter wall 60 of the respective lateral side rail cover 38. Each of the set of back straps 100 associated with a respective lateral side rail cover 38 is positioned on a back side 103 of the perimeter wall 60 of the respective lateral side rail cover 38. Furthermore, a respective one of the set of front straps 98 associated with a respective lateral side rail cover 38 is releasably matable to a respective one of the set of back straps 100 associated with the respective lateral side rail cover 38.

A plurality of first mating members 104 is provided and each of the plurality of first mating members 104 is attached to a front surface 106 of a respective one of the plurality of straps 68. Each of the plurality of first mating members 104 is positioned adjacent to a bottom end 108 of the respective strap 68. Each of the plurality of first mating members 104 may comprise a hook portion of a hook and loop fastener or other type of multiple use, releasable fastener. A plurality of second mating members 110 is provided and each of the plurality of second mating members 110 is attached to the front surface 106 of a respective one of the plurality of straps 68. Each of the plurality of second mating members 110 is positioned adjacent to the bottom end 108 of the respective strap 68 on which the second mating members 110 are disposed. Furthermore, the first mating member 104 on a respective strap 68 is releasably matable to the second mating member 110 on a corresponding one of the plurality of straps 68 for mating the respective strap 68 to the corresponding strap 68. Additionally, each of the second mating members 110 may comprise a loop portion of a hook and loop fastener or other type of multiple user, releasable fastener.

In use, the front side rail cover 34 is positioned over the front side rail 20 of the hospital bed 12 and the back side rail cover 36 is positioned over the back side rail 22 of the hospital bed 12 and each of the set of lateral side rail covers 38 is positioned over a respective lateral side rail 18 of the hospital bed 12. In this way the front side rail cover 34 and the back side rail cover 36 and each of the set of lateral side rail covers 38 inhibits the patient 16 from being injured when the patient 16 laterally strikes against the front side rail 20 or the back side rail 22 or the lateral side rails 18 when the patient 16 is experiencing a seizure. Furthermore, the plurality of cushions 66 inhibits the patient 16 from being injured when the patient 16 strikes downwardly on the front side rail 20 or the back side rail 22 of the set of lateral side rails 18 when the patient 16 is experiencing a seizure. The respective straps 68 on the front side rail cover 34 are extended beneath the front side rail 20 and are mated to each other to retain the front side rail cover 34 on the front side rail 20. The respective straps 68 on the back side rail cover 36 are extended beneath the back side rail 22 and are mated to each other to retain the back side rail cover 36 on the back side rail 22. Additionally, the respective straps 68 on each of the set of lateral side rail covers 38 are mated to each other to retain each of the lateral side rail covers 38 on the respective lateral side rail 18 of the hospital bed 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bed rail padding device for covering bed rails of a hospital bed to inhibit a patient from being injured when the patient is experiencing a seizure, said device comprising:
a hospital bed having a plurality of side rails being distributed around a perimeter of said hospital bed wherein each of said plurality of side rails is configured to inhibit the patient from falling off of said hospital bed;
a plurality of side rail covers, each of said plurality of side rail covers being positionable over a respective one of said plurality of side rails of said hospital bed such that each of said plurality of side rail covers substantially encloses said respective side rail of said hospital bed, each of said plurality of side rail covers being comprised of a resiliently compressible material wherein each of said plurality of side rail covers is configured to inhibit the patient from being injured in the event that the patient experiences the seizure which results in the patient striking laterally against said side rails of said hospital bed;
a plurality of cushions, each of said plurality cushions being strategically positioned on a respective one of said plurality of side rail covers such that each of said plurality of cushions extends over said respective side rail of said hospital bed on which said respective side rail cover is positioned wherein each of said plurality of cushions is configured to inhibit the patient from being injured when the patient strikes downwardly on said respective side rail of said hospital bed in the event that the patient is experiencing the seizure, each of said plurality of cushions having a thickness being greater than a thickness of said respective side rail cover on which each of said plurality of cushions is positioned wherein each of said plurality of cushions is configured to enhance protection for the patient when the patient strikes downwardly on said respective side rail of said hospital bed when the patient is experiencing the seizure; and
a plurality of straps, each of said plurality of straps being coupled to and extending downwardly from a respective one of said plurality of said side rail covers, each of said plurality of straps on a respective one of said plurality of side rail covers being extendable beneath said respective side rail of said hospital bed on which said respective side rail cover is positioned for securing said respective side rail cover on said respective side rail of said hospital bed, a respective pair of said plurality of straps on a respective one of said plurality of side rail covers being releasably matable to each other to inhibit said respective side rail cover from being removed from said respective side rail of said hospital bed.

2. The bed rail padding device according to claim 1, wherein:
said plurality of side rails of said hospital bed includes a front side rail;
said plurality of side rail covers includes a front side rail cover; and
said front side rail cover has a top wall and a perimeter wall extending downwardly from said top wall such that said perimeter wall of said front side rail covers defines an interior space of said front side rail cover thereby enabling said interior space of said front side rail cover to insertably receive said front side rail of said hospital bed.

3. The bed rail padding device according to claim 1, wherein:
said plurality of side rails of said hospital bed includes a back side rail;
said plurality of side rail covers includes a back side rail cover; and
said back side rail cover has a top wall and a perimeter wall extending downwardly from said top wall of said back side rail cover such that said perimeter wall of said back side rail cover defines an interior space of said back side rail cover to insertably receive said back side rail of said hospital bed.

4. The bed rail padding device according to claim 3, wherein:
said perimeter wall of said back side rail cover has a front side and a back side and a bottom edge;
said bottom edge of said front side curves upwardly toward said top wall of said back side rail cover to accommodate a pillow on said hospital bed; and
said bottom edge of said back side curves upwardly toward said top wall of said back side rail cover to accommodate said pillow on said hospital bed.

5. The bed rail padding device according to claim 1, wherein:
said plurality of side rails of said hospital bed includes a set of lateral side rails; and
each of said set of lateral side rails has a front edge and a back edge and a top edge and a sloped edge which slopes upwardly between said front edge and said top edge.

6. The bed rail padding device according to claim 5, wherein:
said plurality of side rail covers includes a set of lateral side rail covers;
each of said set of lateral side rail covers has a top wall and a perimeter wall extending downwardly from said top wall of a respective lateral side rail cover; and
said perimeter wall of each of said set of lateral side rail covers has a forward side and a sloped side which slopes upwardly between said forward side and said top wall of a respective lateral side rail cover thereby enabling said forward side and said sloped side of said perimeter wall of each of said set of lateral side rail covers to conform to said front edge and said sloped edge of a respective lateral side rail of said hospital bed.

7. The bed rail padding device according to claim 2, wherein said cushion on said front side rail cover extends along a full length of said top wall of said front side rail cover.

8. The bed rail padding device according to claim 3, wherein said cushion on said back side rail cover extends along a full length of said top wall of said back side rail cover.

9. The bed rail padding device according to claim 6, wherein said cushion on a respective lateral side rail cover extends along a full length of said top wall of said respective lateral side rail cover such that said cushion on said respective lateral side rail cover terminates at said sloped side of said perimeter wall of said respective lateral side rail cover.

10. The bed rail padding device according to claim 2, wherein each of said plurality of straps associated with said front side rail cover has an upper end being attached to a bottom edge of said perimeter wall of said front side rail cover.

11. The bed rail padding device according to claim 2, wherein:
said plurality of straps associated with said front side rail cover includes a set of front straps and a set of back straps;
each of said set of front straps is positioned on a front side of said perimeter wall of said front side rail cover;
each of said set of back straps is positioned on a back side of said perimeter wall of said front side rail cover; and
a respective one of said set of front straps is releasably matable to a respective one of said set of back straps.

12. The bed rail padding device according to claim 3, wherein each of said plurality of straps associated with said back side rail cover has an upper end being attached to a bottom edge of said perimeter wall of said back side rail cover.

13. The bed rail padding device according to claim 3, wherein:
said plurality of straps associated with said back side rail cover includes a set of front straps and a set of back straps;
each of said set of front straps associated with said back side rail cover is positioned on a front side of said perimeter wall of said back side rail cover;
each of said set of back straps associated with said back side rail cover is positioned on a back side of said perimeter wall of said back side rail cover; and
a respective one of said set of front straps associated with said back side rail cover is releasably matable to a respective one of said set of back straps associated with said back side rail cover.

14. The bed rail padding device according to claim 6, wherein each of said plurality of straps associated with a respective one of said pair of lateral side rail covers has an upper end being attached to a bottom edge of said perimeter wall of said respective lateral side rail cover.

15. The bed rail padding device according to claim 6, wherein:
said plurality of straps associated with each of said pair of lateral side rail covers includes a set of front straps and a set of back straps;
each of said set of front straps associated with a respective lateral side rail cover is positioned on a front side of said perimeter wall of said respective lateral side rail cover;
each of said set of back straps associated with a respective lateral side rail cover is positioned on a back side of said perimeter wall of said respective lateral side rail cover; and
a respective one of said set of front straps associated with a respective lateral side rail cover is releasably matable to a respective one of said set of back straps associated with said respective lateral side rail cover.

16. The bed rail padding device according to claim 1, wherein said bed rail padding device includes a plurality of first mating members;
each of said plurality of first mating members being attached to a front surface of a respective one of said plurality of straps; and
each of said plurality of first mating members being positioned adjacent to a bottom end of said respective strap.

17. The bed rail padding device according to claim 16, wherein:
said bed rail padding device includes a plurality of second mating members;
each of said plurality of second mating members is attached to said front surface of a respective one of said plurality of straps; and
each of said plurality of second mating members is positioned adjacent to said bottom end of said respective strap on which said second mating members are disposed.

18. The bed rail padding device according to claim 17, wherein said first mating member on a respective strap is releasably matable to said second mating member on a corresponding one of said plurality of straps for mating said respective strap to said corresponding strap.

19. A bed rail padding device for covering bed rails of a hospital bed to inhibit a patient from being injured when the patient is experiencing a seizure, said device comprising:
a hospital bed having a plurality of side rails being distributed around a perimeter of said hospital bed wherein each of said plurality of side rails is configured to inhibit the patient from falling off of said hospital bed, said plurality of side rails including a set of lateral side rails and a front side rail and a back side rail, each of said set of lateral side rails having a front edge and a back edge and a top edge and a sloped edge which slopes upwardly between said front edge and said top edge;
a plurality of side rail covers, each of said plurality of side rail covers being positionable over a respective one of said plurality of side rails of said hospital bed such that each of said plurality of side rail covers substantially encloses said respective side rail of said hospital bed, each of said plurality of side rail covers being comprised of a resiliently compressible material wherein each of said plurality of side rail covers is configured to inhibit the patient from being injured in the event that the patient experiences the seizure which results in the patient striking laterally against said side rails of said hospital bed, said plurality of side rail covers including a front side rail cover and a back side rail cover and a set of lateral side rail covers, said front side rail cover having a top wall and a perimeter wall extending downwardly from said top wall such that said perimeter wall of said front side rail covers defines an interior space of said front side rail cover thereby enabling said interior space of said front side rail cover to insertably receive said front side rail of said hospital bed, said back side rail cover having a top wall and a perimeter wall extending downwardly from said top wall of said back side rail cover such that said perimeter wall of said back side rail cover defines an interior space of said back side rail cover to insertably receive said back side rail of said hospital bed, said perimeter wall of said back side rail cover having a front side and a back side and a bottom edge, said bottom edge of said front side curving upwardly toward said top wall of said back side rail cover to accommodate a pillow on said hospital bed, said bottom edge of said back side curving upwardly toward said top wall of said back side rail cover to accommodate said pillow on said hospital bed, each of said set of lateral side rail covers having a top wall and a perimeter wall extending downwardly from said top wall of a respective lateral side rail cover, said perimeter wall of each of said set of lateral side rail covers having a forward side and a sloped side which slopes upwardly between said forward side and said top wall of a respective lateral side rail cover thereby enabling said forward side and said sloped side of said perimeter wall of each of said set of lateral side rail covers to conform to said front edge and said sloped edge of a respective lateral side rail of said hospital bed;
a plurality of cushions, each of said plurality cushions being strategically positioned on a respective one of said plurality of side rail covers such that each of said plurality of cushions extends over said respective side rail of said hospital bed on which said respective side rail cover is positioned wherein each of said plurality of cushions is configured to inhibit the patient from being injured when the patient strikes downwardly on said respective side rail of said hospital bed in the event that the patient is experiencing the seizure, each of said plurality of cushions having a thickness being greater than a thickness of said respective side rail cover on which each of said plurality of cushions is positioned wherein each of said plurality of cushions is configured to enhance protection for the patient when the patient strikes downwardly on said respective side rail of said hospital bed when the patient is experiencing the seizure, said cushion on said front side rail cover extending along a full length of said top wall of said front side rail cover, said cushion on said back side rail cover extending along a full length of said top wall of said back side rail cover, said cushion on a respective lateral side rail cover extending along a full length of said top wall of said respective lateral side rail cover such that said cushion on said respective lateral side rail cover terminates at said sloped side of said perimeter wall of said respective lateral side rail cover;
a plurality of straps, each of said plurality of straps being coupled to and extending downwardly from a respective one of said plurality of said side rail covers, each of said plurality of straps on a respective one of said plurality of side rail covers being extendable beneath said respective side rail of said hospital bed on which said respective side rail cover is positioned for securing said respective side rail cover on said respective side rail of said hospital bed, a respective pair of said plurality of straps on a respective one of said plurality of side rail covers being releasably matable to each other to inhibit said respective side rail cover from being removed from said respective side rail of said hospital bed, each of said plurality of straps associated with said front side rail cover having an upper end being attached to a bottom edge of said perimeter wall of said front side rail cover, said plurality of straps associated with said front side rail cover including a set of front straps and a set of back straps, each of said set of front straps being positioned on a front side of said perimeter wall of said front side rail cover, each of said set of back straps being positioned on a back side of said perimeter wall of said front side rail cover, a respective one of said set of front straps being releasably matable to a respective one of said set of back straps, each of said plurality of straps associated with said back side rail cover having an upper end being attached to a bottom edge of said perimeter wall of said back side rail cover, said plurality of straps associated with said back side rail cover including a set of front straps and a set of back straps, each of said set of front straps associated with said back side rail cover being positioned on a front side of said perimeter wall of said back side rail cover, each of said set of back straps associated with said back side rail cover being positioned on a back side of said perimeter wall of said back side rail cover, a respective one of said set of front straps associated with said back side rail cover being releasably matable to a respective one of said set of back straps associated with said back side rail cover, each of said plurality of straps associated with a respective one of said pair of lateral side rail covers having an upper end being attached to a bottom edge of said perimeter wall of said respective lateral side rail cover, said plurality of straps associated with each of said pair of lateral side rail covers including a set of front straps and a set of back straps, each of said set of front straps associated with a respective lateral side rail cover being positioned on a front side of said perimeter wall of said respective lateral side rail cover, each of said set of back straps associated with a respective lateral side rail cover being positioned on a back side of said perimeter wall of said respective lateral side rail cover, a respective one of said set of front straps associated with a respective lateral side rail cover being releasably matable to a respective one of said set of back straps associated with said respective lateral side rail cover;
a plurality of first mating members, each of said plurality of first mating members being attached to a front surface of a respective one of said plurality of straps, each of said plurality of first mating members being positioned adjacent to a bottom end of said respective strap; and
a plurality of second mating members, each of said plurality of second mating members being attached to said front surface of a respective one of said plurality of straps, each of said plurality of second mating members being positioned adjacent to said bottom end of said respective strap on which said second mating members are disposed, said first mating member on a respective strap being releasably matable to said second mating member on a corresponding one of said plurality of straps for mating said respective strap to said corresponding strap.
